(19) United States
(12) Patent Application Publication
(10) Pub. No.: US 2025/0061045 A1
(43) Pub. Date: Feb. 20, 2025

(54) BINARY INSTRUMENTATION FOR COMPARATIVE PERFORMANCE AND EFFICIENCY ANALYSIS IN EMULATED ENVIRONMENTS

(71) Applicant: Google LLC, Mountain View, CA (US)

(72) Inventor: Christopher Johnson, Mukilteo, WA (US)

(21) Appl. No.: 18/779,505

(22) Filed: Jul. 22, 2024

Related U.S. Application Data
(60) Provisional application No. 63/533,212, filed on Aug. 17, 2023.

(51) Int. Cl. G06F 11/36

(52) U.S. Cl. CPC G06F 11/3612

(57) ABSTRACT

Aspects of the technology provide a software testing framework that can significantly reduce hardware resources needed to validate code modules. This may include employing a hardware emulator capable of instrumenting binaries to produce a trace of operations performed by a given program. The trace of operations performed by the given program may be mapped to representative profiles of operations benchmarked on a hardware system corresponding to the hardware emulated by the hardware emulator. The representative profile may contain sets of representative operations previously performed on the hardware. The mapping may allow for estimates on performance metrics of the given program (e.g., efficacy and/or speed) when run on the hardware. Such estimates may allow for the identification of operations that cause the given program to run inefficiently or slowly on the hardware.

### CROSS-REFERENCE TO RELATED APPLICATIONS

The present application claims the benefit of the filing date of U.S. Provisional Application No. 63/533,212, filed Aug. 17, 2023, the entire disclosure of which is incorporated by reference herein.

### BACKGROUND

Computer software is often evaluated in terms of its efficiency and speed at accomplishing certain tasks. This is to avoid scenarios where users can perceive delays in their interactions with a computing system, or where users can perceive signs of inefficiency, such as short battery life and overheating. “Benchmarks” may be written as programs that measure the execution of some representative workload for the software. The most common way of executing benchmarks is to run them on the intended hardware target and measure how long they take to execute over a number of attempts. As software is changed, the outcome of these benchmarks can be evaluated over time using statistical methods to determine if the performance has improved or regressed. These runs may be used to both optimize software's performance and prevent accidental regressions in performance.

However, this type of approach relies on using real physical hardware (not emulated), which can be expensive depending on the hardware in question. It may provide results applicable only to that specific hardware. Acquiring results on more hardware configurations would involve provisioning more expensive hardware and running more benchmarks, which can be very time-consuming and resource-consuming. Third, timing is highly sensitive to the conditions on the physical device, which makes statistical analysis necessary. These can all be significant drawbacks to robust software development and evaluation.

### BRIEF SUMMARY

Aspects of the technology provide a software testing framework that can significantly reduce hardware resources needed to validate code modules. This may include utilizing a hardware emulator capable of instrumenting binaries to produce a trace of selected operations performed by a given program is employed. The trace of operations performed by the given program may be mapped to a representative profile of operations benchmarked on a hardware system corresponding to the hardware being emulated. The representative profile may contain sets of representative operations previously performed on the hardware. The mapping may allow for estimates on performance metrics of the given program (e.g., efficacy and/or speed) when run on the hardware. Such estimates may allow for the identification of operations that cause the given program to run inefficiently or slowly on the hardware.

On aspect of the technology relates to a method. The method comprising compiling, on a hardware emulator, a first program, wherein the compiled first program includes an ID marker corresponding to an operation of the first program; executing, on the hardware emulator, the compiled first program; generating, by the hardware emulator based on the executing, a trace of the first program, the trace including the ID marker corresponding to the operation of the first program; and mapping, by one or more processors, the trace to one or more benchmarks of a representative operation performed on a hardware system, wherein the mapping includes matching the ID marker of the trace to an ID marker corresponding to the representative operation.

In one example, the method further includes estimating at least one parameter regarding the first program based on the mapping, wherein the at least one parameter pertains to a performance metric of the operation of the first program.

In another example, the method further includes writing, by the hardware emulator, a block record into the first program based on the compiling of the first program, wherein the block record includes the ID marker corresponding to the operation of the first program. In a further example, writing, by the hardware emulator, the block record into the first program includes augmenting the block record to include a description of the operation of the first program. Additionally or alternatively, writing, by the hardware emulator, the block record into the first program is conducted during or following the compiling. Additionally or alternatively, writing, by the hardware emulator, the block record into the first program is conducted during the executing.

In an additional example, the hardware emulator emulates the hardware system.

In another example, the method further includes generating, by the hardware emulator, a second trace of a second program. In a further example, the second program is the first program with one or more edits. In an additional example, the second trace is a trace of only the one or more edits.

In a further example, mapping the trace to the one or more benchmarks further includes statistically refining an accuracy of the benchmarks.

In an additional example, compiling the first program is conducted using LLVM intermediate representation (IR).

Another aspect of the technology relates to a system for testing software. The system comprising a memory including a code repository; one or more processors, the one or more processors configured to: compile, on a hardware emulator, a first program, wherein the compiled first program includes an ID marker corresponding to an operation of the first program, execute, on the hardware emulator, the compiled first program, generate, by the hardware emulator based on the execution, a trace of the first program, the trace including the ID marker corresponding to the operation of the first program, and map the trace to one or more benchmarks of a representative operation performed on a hardware system by a match of the trace to an ID marker corresponding to the representative operation; and a hardware system configured to: run the representative operation, and determine, based on the running of the representative operation, the one or more benchmarks associated with the representative operation.

In one example, the system further includes a developer device. In a further example, the memory is a memory of the developer device. Additionally or alternatively, the one or more processors are one or more processors of a developer device.

In another example, hardware system is a plurality of hardware systems and the hardware emulator is a plurality of hardware emulators.

In an additional example, the operation of the first program is a plurality of operations of the first program and the representative operation is a plurality of representative operations.

In another example, the hardware emulator emulates the hardware system.

In an additional example, the hardware system is one of: a desktop computer, a laptop, a tablet PC, an at-home assistant device, a smart speaker, a temperature unit, a thermostat unit, a mobile phone, a PDA, or a smartwatch.

### BRIEF DESCRIPTION OF DRAWINGS

FIG. 1a is a diagram of components of a software testing framework including a memory, a plurality of hardware emulators, and a developer device in accordance with aspects of the disclosure.

FIG. 1b is a block diagram of a developer device in accordance with aspects of the disclosure.

FIG. 2a is a diagram of components of a software testing framework including a memory, a plurality of hardware systems, and a developer device in accordance with aspects of the disclosure.

FIG. 2b is a block diagram of hardware system(s) in accordance with aspects of the disclosure.

FIG. 3 illustrates an example program structure in accordance with aspects of the disclosure.

FIG. 4a illustrates a diagram of possible flow options of a control flow block of a program in accordance with aspects of the disclosure.

FIG. 4b illustrates a diagram of possible flow options of a control flow block of a program in accordance with aspects of the disclosure.

FIG. 5a illustrates an example block record in accordance with aspects of the disclosure.

FIG. 5b illustrates an example augmented block record in accordance with aspects of the disclosure.

FIG. 5c illustrates an example block record and trace in accordance with aspects of the disclosure.

FIG. 6 illustrates an example representative profile of a set of operations in accordance with aspects of the disclosure.

FIGS. 7a-b illustrate flow diagram of trace generation in accordance with aspects of the disclosure.

### DETAILED DESCRIPTION

### Overview

Aspects of the technology provide a software testing framework that can significantly reduce hardware resources needed to validate code modules. Generally, computer software can be compiled and executed on different types of computer hardware, and the results of which are highly dependent on the properties of a particular hardware device. Evaluating the performance of software on a set of hardware configurations would typically involve acquiring each of those hardware configurations and running the software on each one. This type of approach is often expensive, time consuming, and would require ongoing maintenance to ensure that performance can be accurately evaluated over time as the software is modified.

To address this, according to one aspect of the technology, a hardware emulator capable of instrumenting binaries to produce a trace of selected operations performed by a given program is employed. The trace of operations may provide an approximation of the given program's performance. The trace of operations performed by the given program may be mapped to a representative profile of operations benchmarked on a hardware system corresponding to the hardware being emulated. The representative profile may contain sets of representative operations previously performed on the hardware. The mapping may allow for estimates on performance metrics of the given program (e.g., efficacy and/or speed) when run on the hardware. Such estimates may allow for the identification of operations that cause the given program to run inefficiently or slowly on the hardware.

Generally, programs are configured to run on one or more hardware devices. As such, one or more traces may be produced using one or more hardware emulators; one or more representative profiles may be generated on one or more hardware systems, and the one or more traces may be mapped to the corresponding one or more representative profiles. In this regard, the systems and methods described herein may allow for identification of potential issues in programs on hardware systems without running the programs on the hardware systems. Additionally, the systems and methods described herein may be compatible with a plurality of programming languages, compilers (e.g., the low level virtual machine (LLVM) intermediate representation (IR)), and hardware systems.

In this regard, the systems and methods provided herein provide a software testing framework that can significantly reduce hardware resources, costs and time needed to validate code modules.

### Example Systems

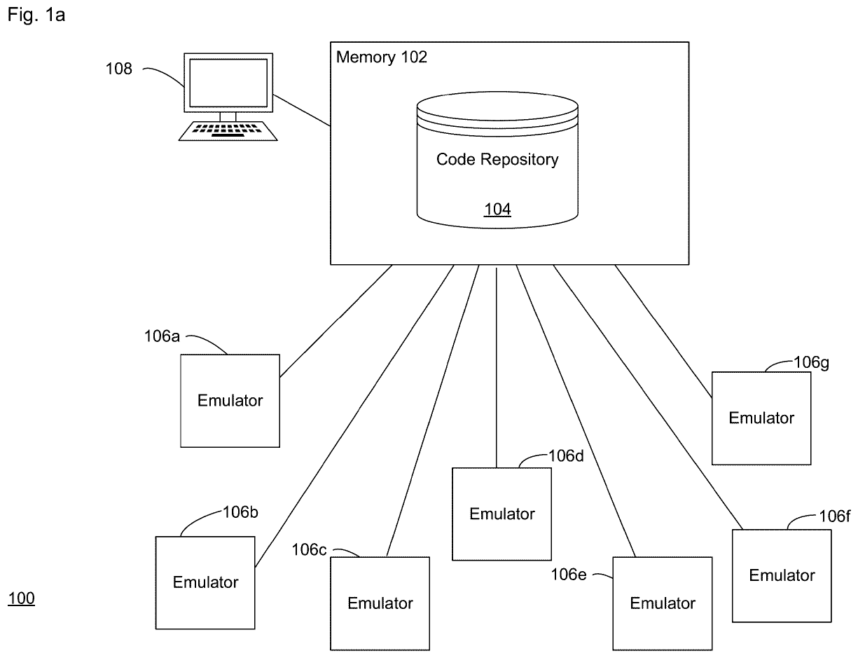

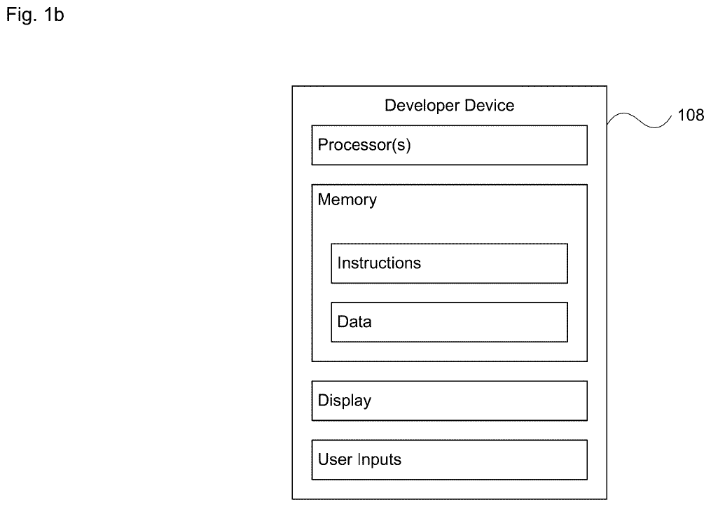

To produce the one or more traces of operations of a program, the program may be run on one or more hardware emulators. FIG. 1a illustrates example configuration 100 of components of the software testing framework. The configuration 100 includes memory 102 including a code repository 104, a plurality of hardware emulators 106a-g, and a developer device 108. While the plurality of hardware emulators 106a-g may be shown separately from developer device 108, in some instances the plurality of hardware emulators 106a-g may be run on the developer device.

Memory 102 can be implemented as one or more of a computer-readable medium or media, a volatile memory unit or units, or a non-volatile memory unit or units. The memory 102 may include, for example, unmanaged flash memory and/or NVRAM (which may be NAND-based memory), and may be embodied as a hard-drive or memory card such as an embedded multimedia card (eMMC) or solid state drive (SSD) card (e.g., “managed NAND” or “managed memory”). Alternatively, the memory 102 may also include removable media (e.g., DVD, CD-ROM or USB thumb drive).

According to one aspect, the memory 102 may be configured to have multiple partitions. In this regard, one or more regions of the memory 102 may be write-capable while other regions may comprise read-only (or otherwise write-protected) memories. In one instance, code repository 104 may include a read-only portion from which a program may be read by the plurality of hardware emulators 106a-g. The read-only portion may allow for the plurality of hardware emulators 106a-g to run the program without altering the program. In this regard, the original program file may be maintained. In one instance, code repository 104 may include a write-capable region. The write-capable portion of code repository 104 may allow for the plurality of hardware emulators 106a-g to instrument binaries on the program such that one or more traces may be extracted. The write-capable portion of the code repository 104 may additionally allow the developer device 108 to add programs to the code repository 104, make one or more edits to programs in the code repository 104, or otherwise work with programs contained in the code repository. Note that a plurality of hardware emulators are shown in FIG. 1, however, in some instances only a trace corresponding to a single hardware system may be produced. In such an example, only one hardware emulator may be used.

The plurality of hardware emulators 106a-g may be programs configured to input code or programs for a given CPU architecture and execute that code by simulating the behavior of that architecture. In this regard, the plurality of hardware emulators 106a-g may be configured to model, or emulate, the behavior of CPU architectures of corresponding hardware systems, for example the plurality of hardware systems 206a-g discussed below. The plurality of hardware emulators 106a-g may include commercially available, free to use, and/or open-source emulators such as QEMU, Android Emulator, iOS Simulator, etc. The plurality of hardware emulators 106a-g may be configured to emulate a plurality of CPU architectures. For example, one or more of the plurality of hardware emulators 106a-g can emulate an advanced RISC machine (ARM) (e.g., ARM64) or other instruction set architecture (e.g., RISCV). In such an example, the one or more of the plurality of hardware emulators 106a-g may be configured to emulate an arm64 machine on an x64 machine. In this regard, the one or more of the plurality of hardware emulators 106a-g may provide a compatibility layer to allow for the ARM64 to run on x64.

The developer device 108 may be a desktop computer, a laptop or tablet PC, etc. As shown in FIG. 1b, the developer device 108 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Configurations may include different combinations of the foregoing; whereby different portions of the instructions and data are stored on different types of media. In some instances, the memory of the developer device 108 may be or include memory 102, including code repository 104.

The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 1b functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of a server. Accordingly, references to a processor or computing device will be understood to include references to a collection of processors or computing devices or memories that may or may not operate in parallel.

The developer device 108 may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices that is operable to display information (e.g., text, imagery and/or other graphical elements). Other output devices, such as speaker(s) may also provide information to users.

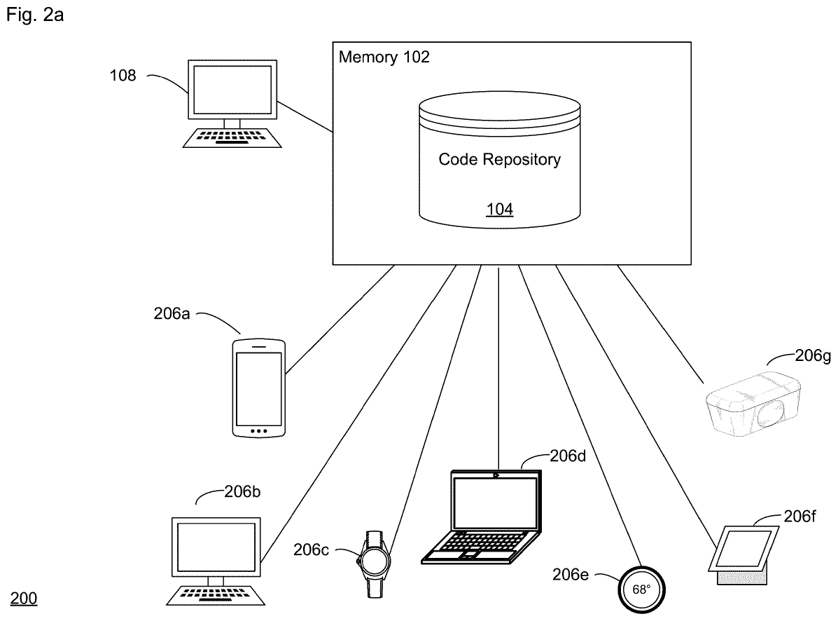

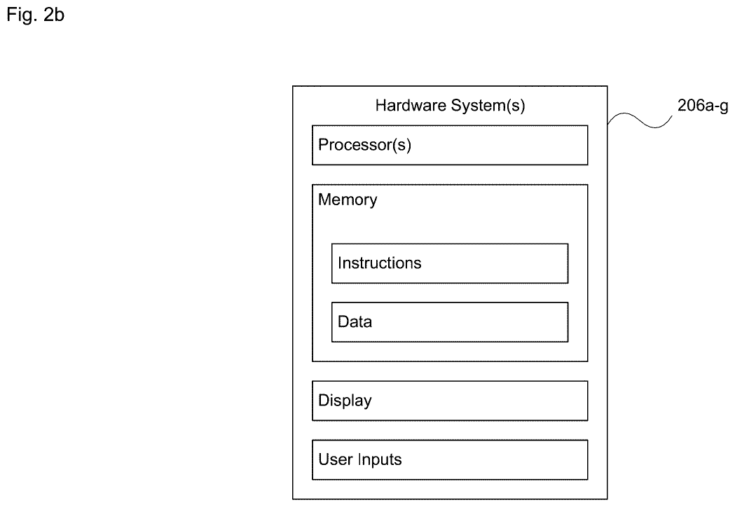

To produce the one or more representative profiles as discussed above, the program may be run on one or more hardware systems. FIG. 2a illustrates example configuration 200 of components of the software testing framework. The configuration 200 includes the memory 102 including code repository 104, a plurality of hardware systems 206a-g, and the developer device 108.

The plurality of hardware systems 206a-g may include one or more of a desktop computer, a laptop or tablet PC, in-home devices that may include portable units (such as an at-home assistant device or a smart speaker), fixed units (such as a temperature/thermostat unit), a personal communication device such as a mobile phone or PDA, or a wearable device such as a smartwatch, etc. As shown in FIG. 2b, the plurality of hardware systems 206a-g may include one or more processors, memory, data, and instructions. The memory stores information accessible by the one or more processors, including instructions and data that may be executed or otherwise used by the processor(s). The memory may be of any type capable of storing information accessible by the processor(s), including a computing device-readable medium. The one or more processors, memory, data, and instructions of the hardware systems 206a-g may be configured in the same or similar manner as the one or more processors, memory, data, and instructions of the developer device 108.

The plurality of hardware systems 206a-g may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices that is operable to display information (e.g., text, imagery and/or other graphical elements). Other output devices, such as speaker(s) may also provide information to users.

Note that a plurality of hardware systems is shown in FIG. 2a. However, in some instances only a representative profile corresponding to a single hardware system may be produced. In such an example, only one hardware system may be used.

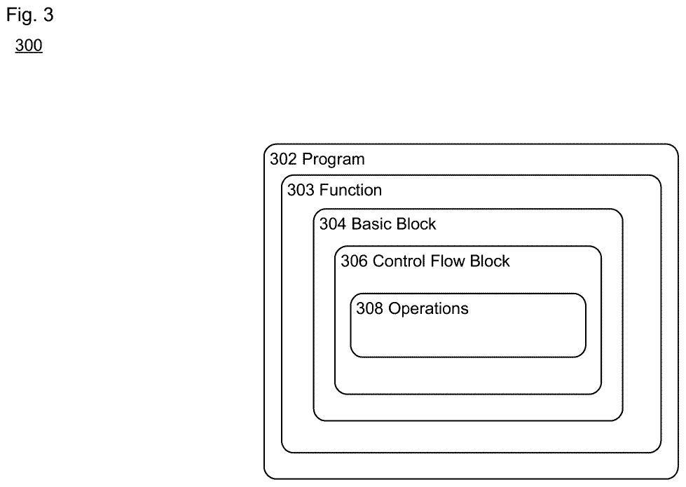

A program as discussed above may include one or more portions. FIG. 3 illustrates an example 300 including program 302. A function 303 of program 302 includes basic block 304. Basic block 304 includes control flow block 306. The control flow block 306 may be a region of a basic block delimited by any control flow changing instructions, including function calls. In this regard, the control flow block may contain operations 308. Operations 308 may include the processes and acts taken by the program 302 while executing basic block 304. Control flow block 306 may execute operations 308 and/or lead to and transfer control (e.g., branch, jump, or a return to a calling basic block). For example, a control flow block 306 may lead to and transfer control to another basic block of program 302, to another program via the operating system executing program 302 (system call), read or write to a memory or cache, or returns to or repeat basic block 304.

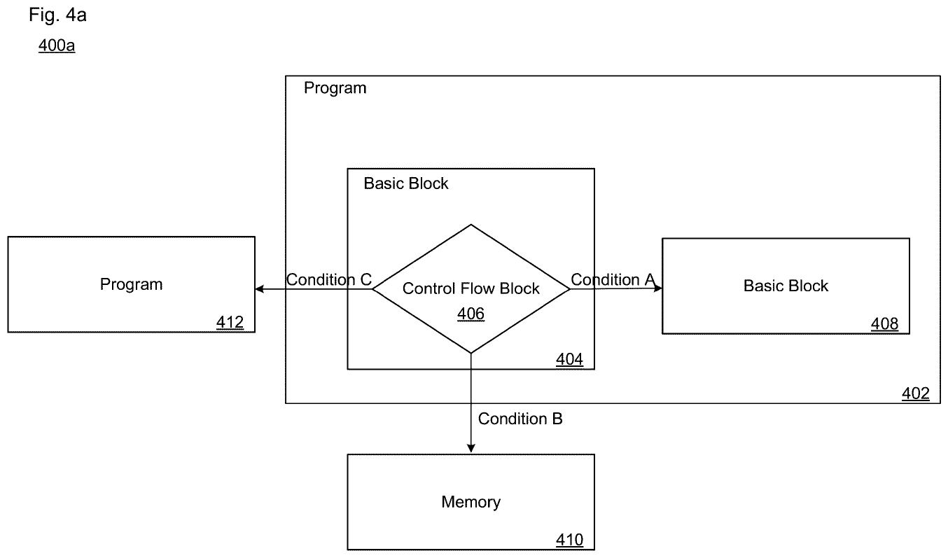

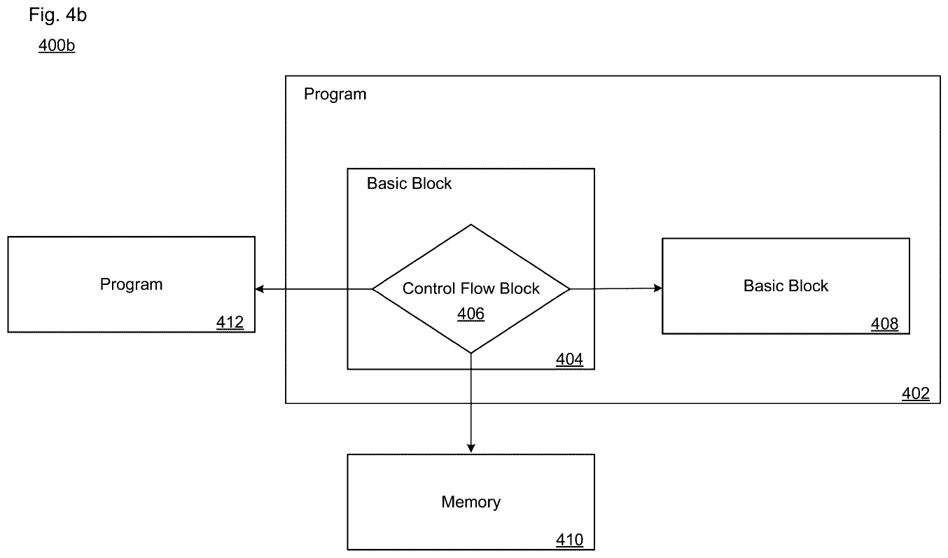

In this regard, FIG. 4a illustrates an example 400a in which a first program 402 includes a first basic block 404 and a second basic block 408. The first basic block 404 includes a control flow block 406. The control flow block 406 may allow for transfer of control from the first basic block 404 based on one or more conditions. For example, upon a condition A being met, the control flow block 406 may transfer control from the first basic block 404 to the second basic block 408. In another example, upon a condition B being met, the control flow block 406 may read or write to a memory 410. In a further example, upon a condition C being met, control flow block 406 may transfer control to a second program 412 via a system call. Example conditions may include, a value being calculated in the operations (e.g., operations 308) of a program, a threshold, the end of loop, etc.

Additionally or alternatively, as illustrated in FIG. 4b, in one example, 400b the control flow block 406 of the first basic block 404 may transfer control from the first basic block 404 to the second basic block 408 without need for a condition to be met. In another example, the control flow block 406 may read or write to memory 410 and/or second program 412 via a system call without need for any conditions to be met.

Note that FIG. 3 illustrates a single basic block 304, and FIGS. 4a-4b illustrate two basic blocks; however, a program may contain numerous basic blocks depending on the program design. Similarly, FIGS. 4a-4b only illustrate read or write operations to a single memory 410 and one second program 412, however, a program may contain calls to numerous memories/caches etc. and/or other programs via a system call depending on the program design.

### Example Method

### Binary Instrumentation

As discussed above, a trace of operations performed by a program may be determined by instrumenting binaries. The trace of operations may be stored on memory 102 and/or the memory of the developer device. Binary instrumentation allows for the modification of a program to include information regarding the performance of the program. Binary instrumentation may be static or dynamic. Static binary instrumentation (SBI) may allow for the modification of the program following or during compilation. Dynamic binary instrumentation (DBI) may allow for the modification of the program during execution. Binary instrumentation of a program may be performed on one or more emulators (e.g., emulators 106a-g) corresponding to hardware the program is intended for.

In some instances, the modification during binary instrumentation may include the creation of a block record. As such, compilation or a compiler pass (“passes” that transform the generated machine code) of a program may result in the creation of the block record, written into the program as annotations. In some instances, a sequence of block records may be produced when multiple control flow blocks are instrumented. In this regard, compilation or a compiler pass that instruments a control flow block may produce a block record. A portion or all of the information contained in the block record may be statically known at the time of compilation.

The block record may be written into a program during execution via DBI or following or during compilation via SBI in a read only form. A block record may encode information regarding the behavior of a control flow block 306, 406 into a basic block 304, 404, 408. In this regard, each control flow block 306, 406 may include a call to a function configured to incorporate the block record corresponding to each basic block 304, 404, 408 therein. The behavior of the control flow block may include one or more operations performed, the transfer of control, calls to other programs (via a system call) and/or memories, etc. For example, the block record may include categorized counts of instructions such as arithmetic operations, vector operations, atomic operations, and memory operations etc. The block record may further include a list of memory locations read to and written from within a control flow block 306, 406. This may be simplified to instead represent only base addresses and alignment, so long as the data is sufficient to determine the behavior of a memory access pattern subject to arbitrary data cache hierarchies.

In some instances, a control flow block may be instrumented by calling to a function (e.g., BlockTrace) configured to record an identification (ID) to a trace buffer (e.g., a log of operations) to create the block record. In this regard, the block record may also include an identification (ID) corresponding to each element thereof. The ID may be a unique ordinal corresponding to an operation. The unique ordinal may be a previously defined value corresponding to an operation of an element.

Additionally, in some instances, the creation of the block record may only correspond to recent execution history of a program. In this regard, the trace buffer may be implemented as a ring buffer. The ring buffer allowing for tracing (e.g., creation of the block record) to remain active only for recent execution steps of the program. In this regard, a block record may only be created of the recent execution. In such an instance, a block record for the portions of the program other than the recent execution may have been previously generated, and may be overwritten by more recent block records. In such an instance, the recent execution steps may correspond to edits to the program.

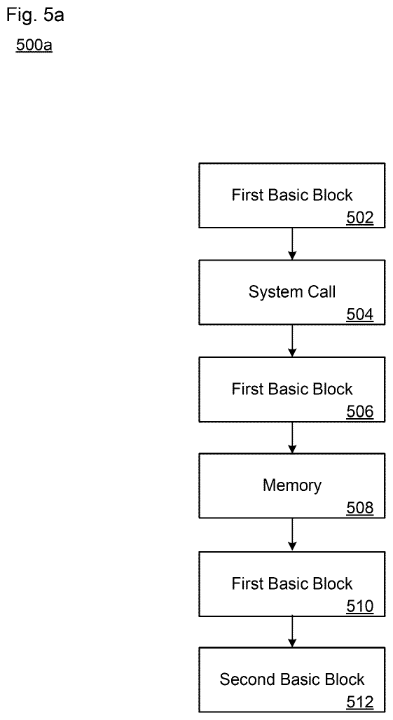

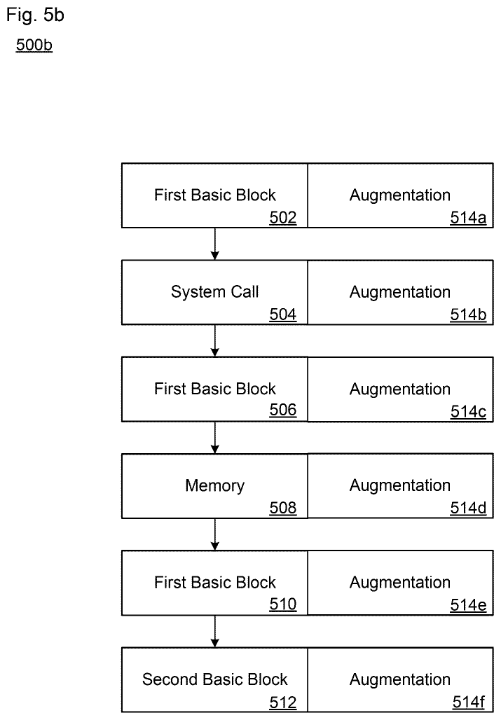

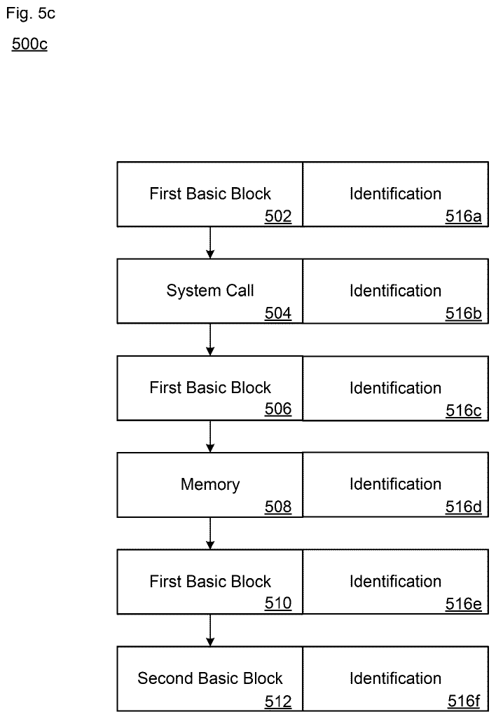

FIG. 5a illustrates an example block record 500a. The block record may include one or more annotations written into each of the basic blocks of a program. In this regard, the block record 500a includes annotation elements describing the function of the program during compilation. At element 502, the block record 500a illustrates that an operation is performed by a first basic block of a first program. At element 504, the block record 500a illustrates a call to the OS (system call) from the first basic block. A system call may include operations on a second program or hardware device. For example, the system call may send a network packet, or perform inter-process communication to a second process. At element 506, the block record 500a illustrates that an operation is performed by the first basic block of the first program. At element 508, the block record 500a illustrates an operation related to a memory from the first basic block. The operation related to the memory may be a read or write operation. Element 508 may further include the location of the memory. Element 510 of the block record 500a illustrates that an operation is performed by the first basic block of the first program. Element 512 of the block record 500a illustrates an operation performed by a second basic block. Each element 502, 504, 506, 508, 510, 512, may additionally include an ID corresponding to the element. In some instances, elements 502, 504, 506, 508, 510, 512 may include information statically known at the time of compilation.

Additionally, the block record may be augmented to include additional information and/or annotations. In this regard, the augmentation may include descriptions of behavior or operations of a control flow block 306, 406. For example, the additional descriptions may include representation of data dependencies within a control flow block 306, 406. For instance, a description of how a result from an operation affects or is used in a future operation. In another example, the additional description may include branch decisions and outcomes, used to measure the behavior of a control flow block subject to arbitrary branch prediction implementations. In another example, the additional description may include executed system calls (e.g., a call to the OS). In such an example, the system call may include requesting a service from the kernel of the OS (e.g., initializing disk controllers, network cards, graphics cards, etc.).

FIG. 5b illustrates an example augmented block record 500b. The augmented block record 500b includes elements 502, 504, 506, 508, 510, 512 where each element includes a corresponding augmentation 514a-f. In this regard, each augmentation 514a-f may include additional descriptions regarding the elements 502, 504, 506, 508, 510, 512. The augmentations 514a-f may additionally include one or more IDs corresponding to the information therein.

Additionally, a trace of operations based on the block record may be generated during execution. The trace may be a record of how the program proceeds through one or more block records of each basic block. In some instances, the trace may include IDs corresponding to each performed element. FIG. 5c illustrates a block record 500c and corresponding trace represented by identification elements 516a-f. The identification elements 516a-f of the trace correspond to the elements 502, 504, 506, 508, 510, 512 of block record 500c. In some instances, the trace may additionally include information or an ID regarding per-block parameters (e.g., parameters of a basic block that determine how the basic block determines an output). Similar to the IDs of the block record, the IDs of the trace may be unique ordinals corresponding to an operation.

In some instances, the order or manner in which the one or more basic blocks are executed may not be known until the time of execution of the program. In this regard, while FIGS. 5a-5c illustrate block records 500a-500c in a particular order corresponding to the order of identification elements 516a-f of the trace; this may not always be the case. As such, the elements of a block record may be in a different order than the trace, meaning that the operations are performed in a different order when executed as opposed to the order reflected in the block record as a result of compilation.

In some instances, the trace and/or block record may include operations not previously identified. In this regard, a new ID may be assigned to such an operation.

### Representative Performance Profiling

As discussed above, representative profiles corresponding to one or more hardware systems (e.g., hardware systems 206a-g) may be generated. The representative profile may be stored on memory 102 and/or the memory of the developer device. The hardware systems may be the systems on which a program is intended to operate. Additionally, the hardware systems may correspond to the one or more emulators (e.g., emulators 106a-g) on which binary instrumentation of the program is conducted. The representative profiles corresponding to one or more hardware systems may contain sets of representative operations. The sets representative operations may be generated by running or compiling one or more representative control flow blocks that include operations likely to be performed in a program on the hardware system corresponding to the representative profile. A representative profile may be generated based on a single run or compile of the one or more representative control flow blocks on the one or more hardware systems. For example, the representative control flow blocks may include operations such as arithmetic operations, successful and unsuccessful read and write operations with memories or caches (e.g., L1 cache, L2 cache, L3 cache, etc.), successful and unsuccessful branch operations, memory access patterns, data dependency patterns, etc. The representative profile may include benchmarks corresponding to each operation of the set of representative operations. The benchmarks may include metrics such as run time of the operation, draw on hardware components, etc. The system call operations may, for instance, include sending an inter-process communication (IPC) message. An ID may be defined for each operation of the set representative operations. Each ID may be a unique ordinal corresponding to an operation.

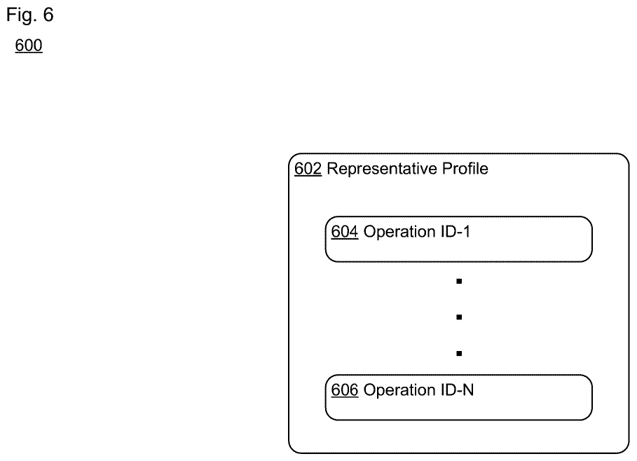

FIG. 6 illustrates an example 600 of a representative profile 602. The representative profile 602 includes a set of operations 604, 606. The representative operations 604, 606 include IDs 1-N. In this regard, the representative profile 602 may include operations 1-N.

In some instances, additional operations may be added as operations not previously contained in the sets of representative operations are identified. In such an instance, control flow block(s) containing the additional operations may be run or compiled on the one or more hardware systems. The results of the run or compile may be added to the representative profile. In one example, the additional operations may be identified by a developer following an edit to a program. In another example, additional operations may be identified during the creation of a block record as discussed above.

In some instances, the representative profile may be statistically refined to improve the accuracy of the benchmarks. Such refinement may lead to more accurate mapping discussed below. For example, such refinement may include finding a distribution of timings for different scenarios. Such as a distribution of timings for system calls, memory accesses, or for more complex scenarios.

### Mapping

As discussed above, the trace of operations determined via binary instrumentation on one or more hardware emulators may be mapped to the representative profiles. The mapping may allow for estimates on performance metrics of the given program (e.g., efficacy and/or speed) when run on the hardware. In this regard, one or more parameters may be estimated that pertain to the performance metric(s) of the given program. Such estimates may allow for the identification of operations that cause the given program to run inefficiently or slowly on the hardware. This may be done without the need to run the program on the hardware.

In some instances, the mapping may be done via the one or more processors of the developer device 108 by matching the IDs 516a-f of the trace of operations to the IDs of operations 604, 606 from the set of representative operations of the representative profile 602. In some instances, the mapping may also include matching the IDs of operations in the elements 502, 504, 506, 508, 510, 512 of the block record 500a, 500b and/or augmentations 514a-f thereof to the IDs of operations 604, 606 from the set of representative operations of the representative profile 602.

The benchmarks associated with the operations 604, 606 may further include use of statistical means. In this regard, accuracy of the mapped benchmarks may be statistically refined (e.g., probability distribution, confidence interval, etc.) to correspond to the operations and details thereof identified in the trace and/or the block record. In this regard, the mapping may allow for identification of areas of the program that are functioning inefficiently, slowly, or otherwise sub-optimally on the corresponding hardware system. Additionally, the mapping may identify worst-case and best-case execution timing ranges. Moreover, statistical methods may be used to provide “most likely” execution timing based on the mapping.

In some instances, the mapping may include determining both successful and unsuccessful execution of operations included in the trace (e.g., successful and unsuccessful read and write operations with memories or caches (e.g., L1 cache, L2 cache, L3 cache, etc.), successful and unsuccessful branch operations, etc.). Such a determination may be made once the cache hierarchy of a system is known. In this regard, the successful and unsuccessful operations may be used to determine certain metrics regarding function of the program. For example, the timing ranges discussed above.

In some instances, a representative profile of a hardware system may be used in mapping of multiple traces generated from a corresponding hardware emulator. For example, a trace of a first program and a trace of a second program may be generated using a computer emulator. In such an example, a representative profile may be generated for a computer by running a set of representative operations on a computer system corresponding to the computer emulator. In this regard, a mapping may be performed for both the trace of the first program and the trace of the second program generated from the computer emulator and the generated representative profile of the computer system. In some instances, mapping of one or more block records of the first program and the second program may also be performed.

In another example, a trace of a first iteration of a program and a second iteration of a program may be generated using a computer emulator. The second iteration of the program may be the first iteration of the program with one or more edits. In such an example, a representative profile may be generated for a computer by running a set of representative operations on a computer system corresponding to the computer emulator. In this regard, a mapping may be performed for both the first iteration of the program and the trace of the second iteration of the program generated from the computer emulator and the generated representative profile of the computer system. Additionally, as discussed above, the trace of the second iteration of the program may only include elements corresponding to the one or more edits. In some instances, mapping of one or more block records of the first iteration and the second iteration of a program may also be performed.

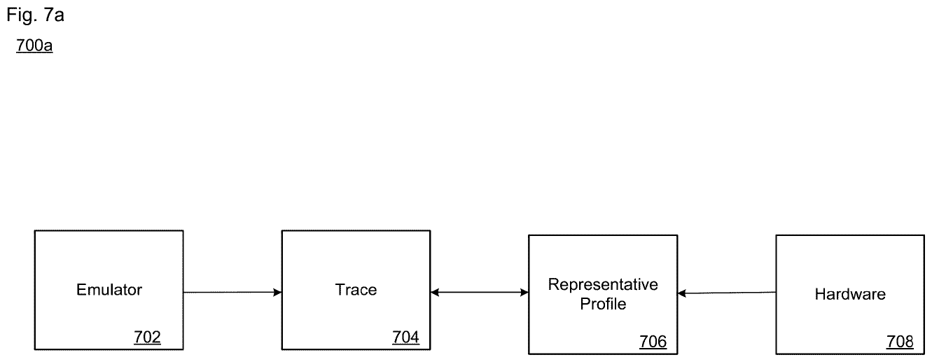

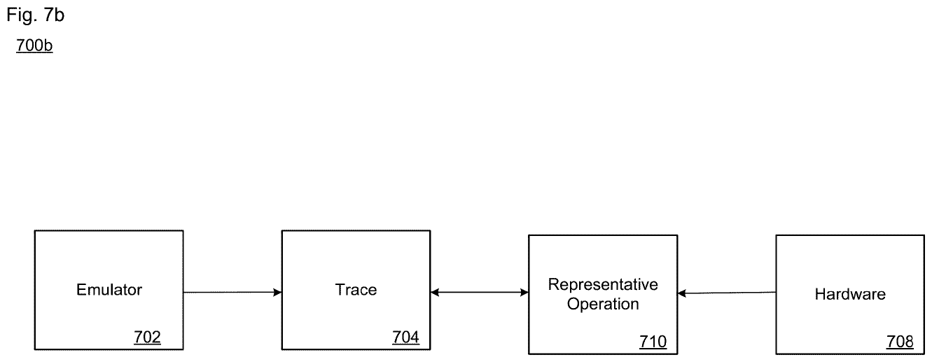

FIG. 7a illustrates an example mapping flow 700a in accordance with aspects of the system. The mapping flow 700a illustrates that emulator 702 is used to generate a trace 704. The trace 704 may be generated by the emulator 702 in the same manner as discussed above with reference to the generation of the block record 500a, 500b, 500c. In this regard, generating, by one or more processors, a trace of one or more operations performed by a program on a hardware emulator may include running, on the hardware emulator, a program, wherein running the program includes compiling the program, and writing, by the hardware emulator, the trace of one or more operations based on the execution of the compiled program. The trace may also include one or more ID markers corresponding to the one or more operations. Generating the trace may further include, writing, by the hardware emulator, one or more block records into the program based on the compiling. The one or more block records may also include one or more ID markers corresponding to the one or more operations thereof.

The mapping flow 700a further illustrates hardware 708 is used to generate representative profile 706. The representative profile 706 may be generated by the hardware 708 in the same manner as discussed above with reference to the generation of the representative profile 602. In this regard, one or more processors may receive one or more benchmarks associated with each operation of a set of operations, and one or more processors may generate a representative profile of the set of operations based on the one or more benchmarks. Each operation of the set of operations may be assigned an ID marker.

The trace 704 may then be mapped to the representative profile 706. Similarly, the mapping may be conducted in the same manner as discussed above. In this regard, mapping, by one or more processors, the trace of one or more operations to the representative profile of the set of operations may include matching the one or more ID markers corresponding to the one or more operations of the trace to one or more of the ID markers of one more of the set of operations of the representative profile. The mapping may further include matching the one or more ID markers corresponding to the one or more operations of the one or more block records to one or more of the ID markers of one more of the set of operations of the representative profile.

FIG. 7b illustrates another example mapping flow 700b in accordance with aspects of the system. The mapping flow 700b illustrates that emulator 702 is used to generate a trace 704. The trace 704 may be generated by the emulator 702 in the same manner as discussed above with reference to the generation of the block record 500a, 500b, 500c. In this regard, the first program may be compiled on a hardware emulator. The compiled first program may include an ID marker corresponding to an operation of the first program. The compiled first program may then be executed on the hardware emulator. In this regard, a trace of the first program may be generated by the hardware emulator based on the execution of the first program. Additionally, the trace may include the ID marker corresponding to the operation of the first program.

The mapping flow 700b further illustrates hardware 708 is used to generate one or more benchmarks of a representative operation 710. The one or more benchmarks of the representative operation 710 may be in the same manner as discussed above with reference to the generation of the representative profile 602.

The trace 704 may then be mapped to the one or more benchmarks of the representative operation 710. Similarly, the mapping may be conducted in the same manner as discussed above. In this regard, the trace may be mapped by one or more processors to one or more benchmarks of a representative operation performed on a hardware system. The mapping may include matching the ID marker of the trace to an ID marker corresponding to the representative operation.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A method comprising:
compiling, on a hardware emulator, a first program, wherein the compiled first program includes an ID marker corresponding to an operation of the first program;
executing, on the hardware emulator, the compiled first program;
generating, by the hardware emulator based on the executing, a trace of the first program, the trace including the ID marker corresponding to the operation of the first program; and
mapping, by one or more processors, the trace to one or more benchmarks of a representative operation performed on a hardware system, wherein the mapping includes matching the ID marker of the trace to an ID marker corresponding to the representative operation.

2. The method of claim 1, further comprising estimating at least one parameter regarding the first program based on the mapping, wherein the at least one parameter pertains to a performance metric of the operation of the first program.

3. The method of claim 1, further comprising writing, by the hardware emulator, a block record into the first program based on the compiling of the first program, wherein the block record includes the ID marker corresponding to the operation of the first program.

4. The method of claim 3, wherein writing, by the hardware emulator, the block record into the first program includes augmenting the block record to include a description of the operation of the first program.

5. The method of claim 3, wherein writing, by the hardware emulator, the block record into the first program is conducted during or following the compiling.

6. The method of claim 3, wherein writing, by the hardware emulator, the block record into the first program is conducted during the executing.

7. The method of claim 1, wherein the hardware emulator emulates the hardware system.

8. The method of claim 1, further comprising generating, by the hardware emulator, a second trace of a second program.

9. The method of claim 8, wherein the second program is the first program with one or more edits.

10. The method of claim 9, wherein the second trace is a trace of only the one or more edits.

11. The method of claim 1, wherein mapping the trace to the one or more benchmarks further includes statistically refining an accuracy of the benchmarks.

12. The method of claim 1, wherein compiling the first program is conducted using LLVM intermediate representation (IR).

13. A system for testing software, the system comprising:
a memory including a code repository;
one or more processors, the one or more processors configured to:
compile, on a hardware emulator, a first program, wherein the compiled first program includes an ID marker corresponding to an operation of the first program,
execute, on the hardware emulator, the compiled first program,
generate, by the hardware emulator based on the execution, a trace of the first program, the trace including the ID marker corresponding to the operation of the first program, and
map the trace to one or more benchmarks of a representative operation performed on a hardware system by a match of the trace to an ID marker corresponding to the representative operation; and
a hardware system configured to:
run the representative operation, and
determine, based on the running of the representative operation, the one or more benchmarks associated with the representative operation.

14. The system of claim 13, further comprising a developer device.

15. The system of claim 14, wherein the memory is a memory of the developer device.

16. The system of claim 14, wherein the one or more processors are one or more processors of the developer device.

17. The system of claim 13, wherein the hardware system is a plurality of hardware systems and the hardware emulator is a plurality of hardware emulators.

18. The system of claim 13, wherein the operation of the first program is a plurality of operations of the first program and the representative operation is a plurality of representative operations.

19. The system of claim 13, wherein the hardware emulator emulates the hardware system.

20. The system of claim 13, wherein the hardware system is one of: a desktop computer, a laptop, a tablet PC, an at-home assistant device, a smart speaker, a temperature unit, a thermostat unit, a mobile phone, a PDA, or a smartwatch.
